(19) United States
(12) Patent Application Publication
(10) Pub. No.: US 2005/0053687 A1
(43) Pub. Date: Mar. 10, 2005

(54) Injection molding machine

(76) Inventors: Walther Pitscheneder, Sierning (AT); Helmut Naderhirn, Perg (AT)

Correspondence Address: NOTARO AND MICHALOS, 100 DUTCH HILL ROAD, SUITE 110, ORANGEBURG, NY, 10962-2100, US

(21) Appl. No.: 10/936,043

(22) Filed: Sep. 8, 2004

(30) Foreign Application Priority Data
Sep. 10, 2003 (AT) GM 619/2003

(51) Int. Cl. B29C 45/42

(52) U.S. Cl. 425/190; 425/556

(57) ABSTRACT

Injection molding machine with a mold that can be opened end closed via a closure device and with an injection unit for the introduction of a liquid molding compound into the closed mold, and with at least one replaceable component, the replaceable component (2, 3, 9, 15, 15b, 17) being provided with at least one transponder (7) which can be read out in contactless manner by means of a reading device (8).

The invention relates to an injection molding machine with a mold that can be opened and closed via a closure device and with an injection unit for the introduction of a liquid molding compound into the closed mold and with at least one replaceable component. It is already known to code replaceable molding tools, for example by means of bar codes. However, the coding possibilities are limited. There is also the danger of contamination of the bar code, in particular in the often tough machine environment.

The object of the invention is to create an improved injection molding machine with which a high degree of automation can be achieved when replaceable components are connected. Convenience and safety when operating the injection molding machine are also to be thereby enhanced.

According to the invention this is achieved in that the replaceable component is provided with at least one transponder which can be read out in contactless manner by means of a reading device.

Transponders are known per se. They serve to create a contactless communication between the, in most cases miniaturized, transponder and a reading device, data transport being possible in both directions. Thus generally speaking data can be read out from the transponder and frequently data can also be written into a memory of the transponder. There are active transponders which are provided with their own energy source, for example a battery. Increasing use is also being made of passive transponders which obtain the supply energy for the electronic circuits at the transponder from the interrogating electromagnetic field of the reading device. To this end, in addition to a receiving antenna or coil, these passive transponders frequently also have a resonance capacitor.

Through the use according to the invention of transponders with replaceable components of an injection molding machine, an extensive automatic identification of the connected replaceable components can take place.

Unlike with the known bar codes, the quantity of data that can be stored in a transponder is much greater * which is a decisive advantage in practice, alongside the operationally secure and rapid reading out of the transponder data, especially when the replaceable component is a complex device, such as for example a handling apparatus, for the removal of the injection moldings. Numerous equipment-specific data, such as maximum strokes, maximum movement speeds, etc. can then be transmitted. A customarily present electronic machine control system that is connected to the reading device can then, with the knowledge of these handling apparatus-specific data, effect an optimized, adapted control of the handling apparatus.

Transponders can also * unlike the known bar codes * be connected to sensors, for example to pressure and temperature sensors. These can also be developed at the transponder itself. The transponder thus permits not only an identification of the connected replaceable part. Rather, it can be additionally or alternately used to transmit sensor data. For example, when it is used in a replaceable plasticizing cylinder, temperature and pressure data can be sent to the machine control system.

When using transponders on a plasticizing screw it is preferably possible that the machine control system, depending on the transponder data of the plasticizing screw, automatically carries out a torque limitation upon driving of the plasticizing screw.

Other possible places for the use of the transponder on the injection molding machine are the injection mold itself, the gripper head of a handling apparatus or a replaceable transport device for the finished injection moldings. Other applications are also perfectly conceivable and possible. Some of these will be further described below.

Further advantages and details of the invention are explained in more detail with the help of the following description of figures.

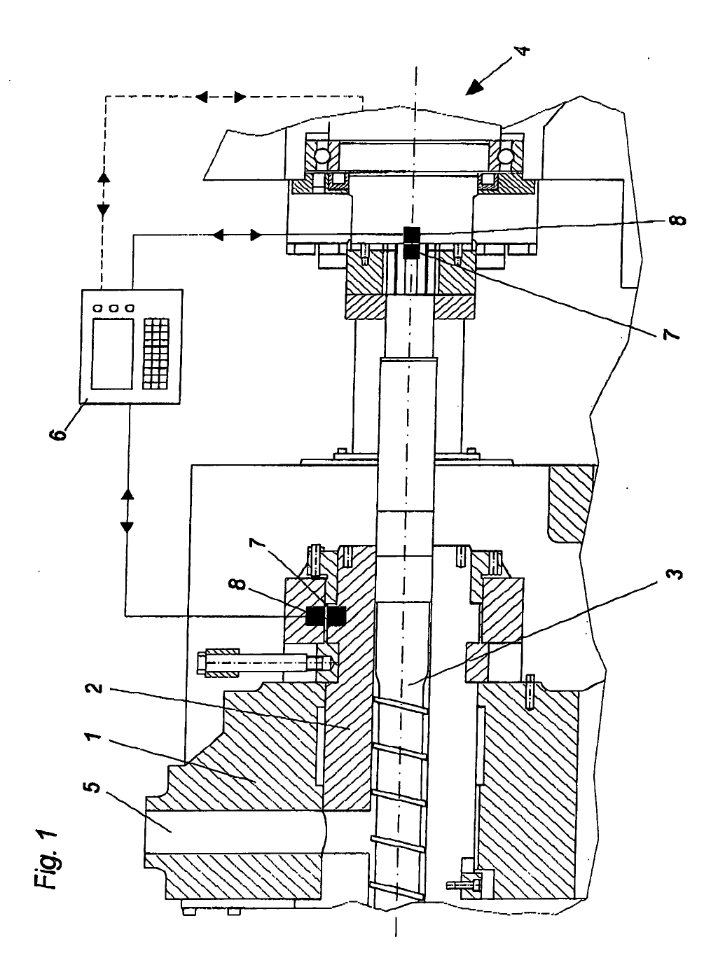

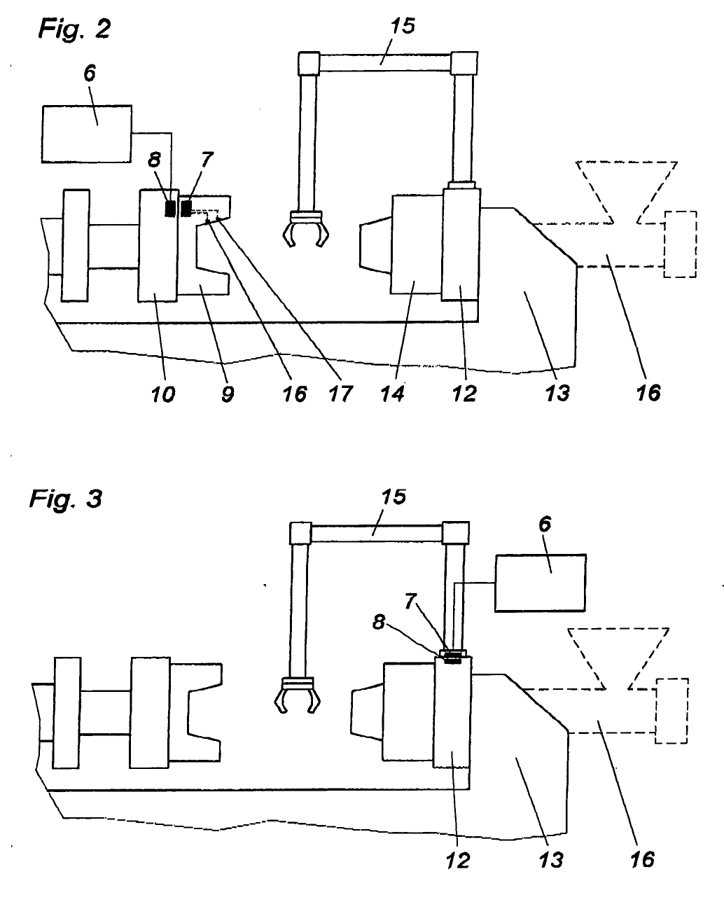

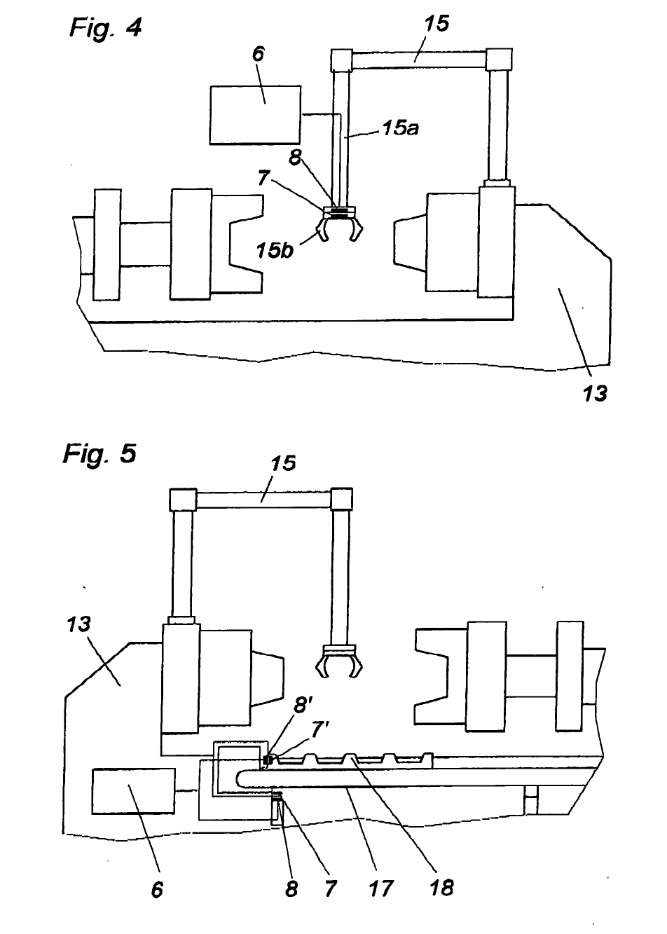

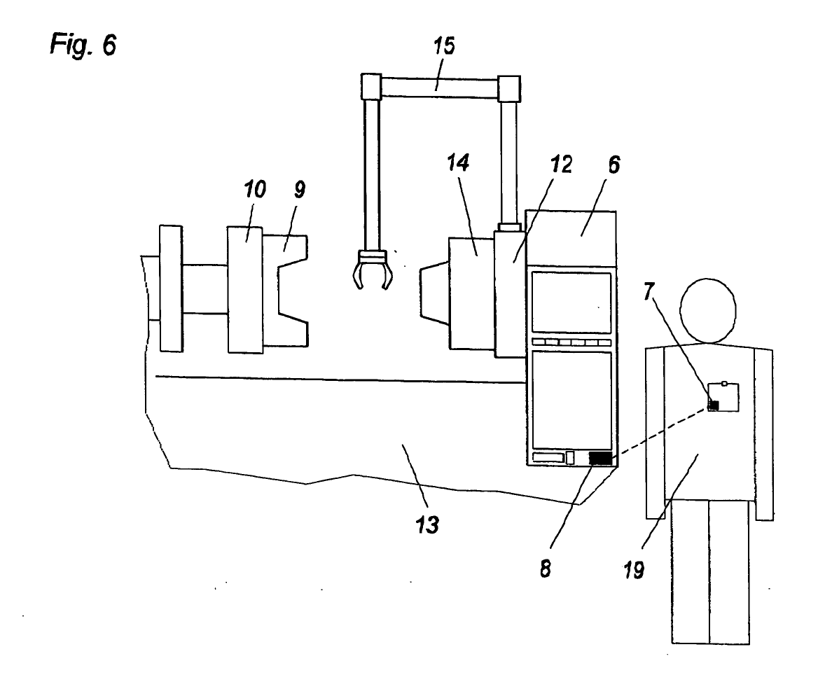

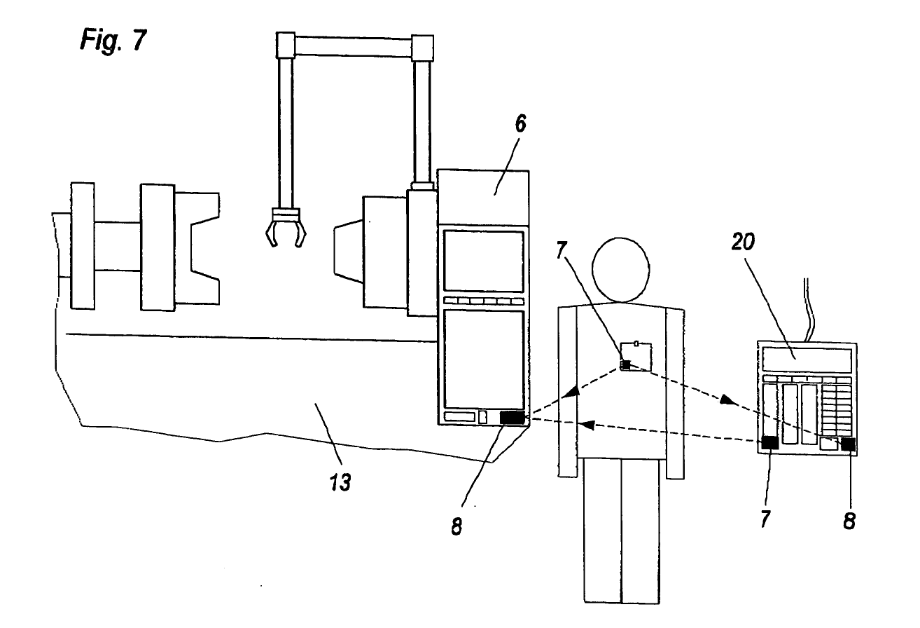

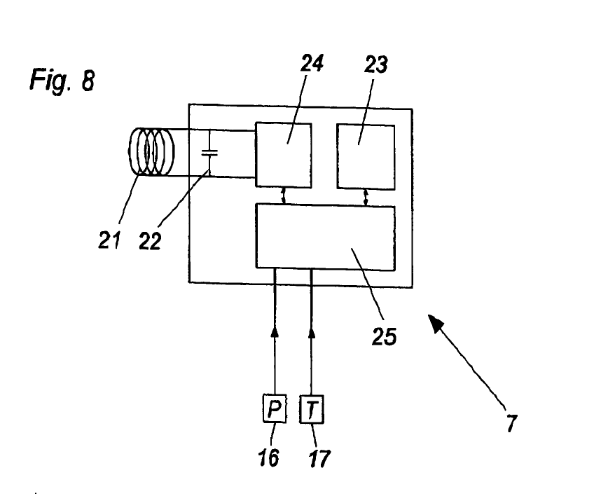

FIG. 1 shows a schematic section through the rear part of a plasticizing cylinder together with plasticizing screw and Its drive. FIG. 2 shows In a schematic side view a section cut from an injection molding machine with a transponder in a mold half. FIG. 3 shows In a schematic side view a part of an injection molding machine with a transponder in a handling apparatus. FIG. 4 shows in a schematic side view a section cut from an injection molding machine with a transponder in a gripper head of a handling apparatus. FIG. 5 shows in a schematic side view a section onto an injection molding machine with a transponder in a transport device for the manufactured injection moldings. FIG. 6 shows a schematic embodiment with a transponder allocated to an operator for the changing or fixing of access entitlement. FIG. 7 shows an embodiment in which on the one hand a transponder is allocated to an operator and on the other a transponder is allocated to a remote-control system. FIG. 8 shows a schematic structure of an embodiment of a suitable passive transponder.

In the case of the embodiment represented in FIG. 1, a replaceable plasticizing cylinder 2 is inserted into a casing 1. A plasticizing screw 3 is housed rotatable in this plasticizing cylinder 2 in a manner known per se, the plasticizing screw being driven via a schematically represented drive unit 4. The granules are fed via the channel 5.

According to the invention the plasticizing cylinder is fitted with a transponder. A reading device in the casing 1 is in a position to read out the data of this transponder after the insertion of the plasticizing cylinder and relay them to the schematically represented electronic machine control system 6 for the whole injection molding machine. The transponder data can provide the machine control system 6 with numerous items of information about the inserted plasticizing cylinder, in particular about its dimensions and other physical properties.

In the case of the shown embodiment in FIG. 1, the plasticizing screw is also fitted with a transponder 7 which can be read by a reading device 8. Here, too, it is possible to quickly detect the inserted plasticizing screw together with its properties and send these data to the machine control system in order to optimize the programme sequence. In particular it is possible that the machine control system fixes or changes the movement sequence of the plasticizing screw 3 depending on the transponder data read by the reading device 8. Above all it is advantageous if the torque of the drive unit 4 is changed and limited depending on the inserted plasticizing screw or the corresponding transponder data.

In the case of the embodiment represented in FIG. 2, the transponder 7 is arranged In the mold half 9. This mold half 9 is housed on a moving platen which carries the reading device 8. This moving platen can be moved in a manner known per se via a closure system that is only partially represented. Located on the other side is the fixed platen 12 which is affixed directly to the machine frame 13. It carries the second mold half 14 to which a schematically represented handling apparatus 15 is affixed.

Two sensors 16, 17 are also arranged on the mold half 9, for example for pressure and temperature, which are in communication with the transponder.

In principle it is also possible to integrate these sensors in or at the transponder chip. It is thus not only possible to identify the mold half quickly and unequivocally, using the transponder data, but rather also during the injection molding process, to supply the machine control system with process data which can then initiate corresponding regulation processes. Such a transponder can also be connected to further sensors, for example via the opening and closure paths. Thus the closure speeds can then also be detected and regulated. Temperature sensors can also for example detect the temperature of the cooling water or the air. FIG. 2 also shows schematically on the extreme right an injection unit 16 which for example comprises the parts represented section-wise in FIG. 1.

In the case of the embodiment represented in FIG. 3, the transponder 7 is affixed to the replaceable handling apparatus 16. The reading device 8 for the transponder is arranged at the fixed platen 12. It is in communication with the electronic machine control system 6. Here too, data identifying the handling apparatus 15, in particular the maximum movement strokes, can again easily be passed on in turn to the machine control system.

FIG. 4 shows en embodiment in which the transponder 7 is housed in the gripper head 15b of the handling apparatus, while the reading device 8 is arranged at the end of the arm 15a of the handling apparatus 15.

In the case of the embodiment represented in FIG. 5a transponder 7 is affixed to a conveyance device 17 which can be releasably affixed to the machine frame 13. A reading device 8 at the machine frame 13 can read out the transponder data and thus identify the connected conveyor belt or the transport device 17.

A further transponder 7 with reading device 8 can serve to identify the movable pallets 18 (trays) and track them on their path.

In the case of the embodiment represented in FIG. 6, the operator 19 wears a transponder 7 which can be read by a reading device 8 of the machine control system 6. Thus it is possible to realize an access-control device. This can firstly limit access to the injection molding machine itself, for example if the latter is operating and the person approaches in a safety zone. An alarm may then sound, for example, or the machine be switched off. It is also possible to fix or limit access to the machine control system itself via the communication of the reading device with the transponder. It is particularly advantageous if the access-control device enables different levels of possible adjustment of the machine control system, depending on the read transponder data. The machine control system thus automatically recognizes which person is approaching and thus enables different operating levels. It is also possible, via the transponder, to change convenience settings, for example in terms of the screen representation, such as the language preferred by the operator, colour or adapted menu presentation.

FIG. 7 shows an embodiment in which additionally a transponder 7 is also provided at a remote control system 20 which also has a reading device 8 for the transponder 7 on the operator.

The transponder 7 worn by the operator can thus be read by two reading devices at the fixed machine control system 6 and at the remote-control system 20. On the other hand however, the reading device 8 at the machine control system 6 is also suitable for reading the transponder at the remote-control system 20 and thus for identifying the latter. In this way the problem of a collision when there are several remote-control systems in a space with different injection molding machines and their control systems can be avoided.

FIG. 8 shows an example of a passive transponder 7 with an antenna 21. This can be developed as an air coil. However, it can also be integrated on a transponder chip or otherwise installed. Furthermore, a resonance capacitor 22 is provided. The transponder 7 can also be in communication with sensors 16 for pressure and 17 for temperature. The sensor data can either be transmitted direct to the reading device and/or stored in the memory 23. It is also possible to house the sensors 16 and 17 on the chip of the transponder or a common carrier. It is also perfectly conceivable and possible to record physical variables other than pressure and temperature.

The schematically represented HF part 24 comprises a rectifier and ensures the power supply of the supplier. It also modulates or demodulates the signals in order to make possible a date transmission between the reading device that is not represented and the control logic. This control logic comprises, in a manner known per se, a clock generator and a sequence and memory-control system as well as, optionally, an encryption logic. The control logic 25 is in communication with a memory 23, for example an EEPROM.

Such a passive transponder obtains the energy from the field of the reading device. Preferably, however, active transponders can also be used in which batteries, for example flexible flat cells or button cells ensure the power supply.

The transponders can not only be read. Rather, it is also possible to write data into the memory of the transponder. These data can be for example data about the operating period used, about the maximally exposed loads. It is thus possible to also give every replaceable component data about the history of its use. These data can be taken into account during following uses or later permit a statistical evaluation.

1. Injection molding machine with a mold that can be opened and closed via a closure device and with an injection unit for the introduction of a liquid molding compound into the closed mold, and with at least one replaceable component, characterized in that the replaceable component is provided with at least one transponder which can be read out in contactless manner by means of a reading device.

2. Injection molding machine according to claim 1, characterized in that a replaceable component is a plasticizing cylinder of the injection unit (FIG. 1).

3. Injection molding machine according to claim 1, characterized in that a replaceable component is a plasticizing screw of the injection unit (FIG. 1).

4. Injection molding machine according to claim 1, characterized in that a replaceable component is a mold half, able to be releasably affixed to a platen of the mold (FIG. 2).

5. Injection molding machine according to claim 1, characterized in that a replaceable component is a handling apparatus, able to be releasably affixed to a machine frame or a fixed platen of the injection molding machine, the handling apparatus being adapted for the removal of injection moldings from the opened mold (FIG. 3).

6. Injection molding machine according to claim 1, characterized in that a replaceable component is a gripper head, able to be releasably affixed to a handling apparatus.

7. Injection molding machine according to claim 1, characterized in that a releasable component is an injection molding part transport device or a conveyor belt, able to be releasably affixed to the machine frame (FIG. 5).

8. Injection molding machine according to claim 1, characterized in that a replaceable component is, in operation, fixedly connected to another component of the injection molding machine.

9. Injection molding machine according to claim 1, characterized in that a replaceable component is moveably or rotatably mounted on another component of the injection molding machine.

10. Injection molding machine with an electronic machine control system according to claim 1, characterized in that the reading device is connected to the electronic machine control system or is at least partially integrated therein.

11. Injection molding machine according to claim 10, characterized in that the machine control system fixes, changes or limits the movement sequence of at least one component of the injection molding machine depending on the transponder data read out by the reading device.

12. Injection molding machine according to claim 3, characterized in that the machine control system changes or limits the torque of the drive unit for the plasticizing screw depending on the transponder data.

13. Injection molding machine according to claim 1 characterized in that the transponder or its antenna or transmit/receive coil is surrounded by a dielectric ceramic, ferrite or plastic material or is attached to this.

14. Injection molding machine according to claim 1, characterized in that the reading device or its antenna or transmit/receive coil is surrounded by a dielectric ceramic, ferrite or plastic material or is attached to this.

15. Injection molding machine according to claim 1, characterized in that the reading device and the transponder are parts of a RFID system.

16. Injection molding machine according to claim 1, characterized in that the transponder has a nonvolatile memory.

17. Injection molding machine according to claim 1, characterized in that the reading device is also developed as a writing device by means of which data can be transmitted to the transponder.

18. Injection molding machine according to claim 1, characterized in that in the mold cavity at least one pressure or temperature sensor is arranged which is in communication with the transponder.

19. Injection molding machine according to claim 1, characterized in that the at least one sensor is integrated in or at the transponder.

20. Injection molding machine according to claim 1, characterized in that the transponder and the receive unit of the reading device are arranged close each other when the replaceable component is fitted.

21. Injection molding machine with an electronic machine control system, in which an access-control device fixes or limits access to the injection molding machine or change possibilities at the machine control system, characterized in that the access-control device has a transponder that can be allocated to the operator and a reading device allocated to the machine control system for the transponder.

22. Injection molding machine according to claim 21, characterized in that the access-control device enables different levels of possible adjustment of the machine control system depending on the read transponder data.

23. Injection molding machine with an electronic machine control system, characterized in that a reading device for a transponder allocated to an operator is provided and the screen representation of the machine control system is adapted depending on the transponder read.

24. Injection molding machine with an electronic machine control system, characterized in that an electronic contactless remote-operation system is provided, the remote-operation system being fitted with a transponder and the machine control system with a reading device for the transponder.
